(19) United States
(12) Patent Application Publication
(10) Pub. No.: US 2014/0279502 A1
(43) Pub. Date: Sep. 18, 2014

(54) System and Method of Processing Payment Transactions

(71) Applicant: ITS, INC., Johnston, IA (US)

(72) Inventors: Terry Dooley, West Des Moines, IA (US); Manish Nathwani, Johnston, IA (US); Stephan Thomasee, Johnston, IA (US); Scott Green, West Des Moines, IA (US); Mindy Cunningham, Norwalk, IA (US); Christa Addy, Des Moines, IA (US)

(73) Assignee: ITS, Inc., Johnston, IA (US)

(21) Appl. No.: 13/799,994

(22) Filed: Mar. 13, 2013

(51) Int. Cl. G06Q 20/38

(52) U.S. Cl. CPC G06Q 20/3821
USPC 705/44

(57) ABSTRACT

A system and method for processing payment transactions via payment devices are provided. Issuer application selection criteria associated with a payment device, merchant application selection criteria associated with an acceptance device, and/or payment network card program file(s) may be evaluated to determine the payment application to be used for processing a payment transaction.

### FIELD OF THE INVENTION

The invention relates to processing payment transactions. In particular, the invention relates to processing payment transactions via payment devices.

### BACKGROUND OF THE INVENTION

The International Standards Organization (ISO) manages the contact/contactless specifications for chip technology. A subset of this technology is managed by an organization (EMVCo) that manages, maintains and enhances the EMV (Europay, MasterCard and Visa) Integrated Circuit Card Specifications to ensure global interoperability of chip-based payment cards (EMV card) with payment acceptance devices including point of sale terminals, ATMs, mobile devices, and/or other acceptance devices. In order for the US payments industry to move towards using chip technology, the technology must accommodate merchant choice (for example, choice in selecting an issuer payment application). A merchant would like to have a choice due to various factors, such as, specific network affiliations, least cost routing, etc. Furthermore, the technology should allow issuers to add and remove affiliation without undue burden.

### SUMMARY OF THE INVENTION

Various systems, computer program products, and methods for processing payment transactions via payment devices are provided. In some implementations, a user may present a payment device at a reader device coupled to an acceptance device to initiate a payment transaction. In some implementations, issuer application selection criteria associated with the payment device, merchant application selection criteria associated with the acceptance device, and/or payment network card program file(s) may be evaluated to determine the payment application to be used for processing the payment transaction.

### BRIEF DESCRIPTION OF THE DRAWINGS

FIG. 1 is a block diagram illustrating an example of a system for processing payment transactions according to various implementations of the invention.

FIG. 2 illustrates an exemplary data flow diagram illustrating exemplary process relationships in a system for processing payment transactions, according to various aspects of the invention.

FIG. 3 is a diagram illustrating an example of generating a candidate list, according to various implementations of the invention.

FIG. 4 is a flow diagram illustrating an example of a process of processing a payment transaction, according to various implementations of the invention.

### DETAILED DESCRIPTION

According to various implementations of the invention, various systems and methods may facilitate payment transactions via payment devices. FIG. 1 is a block diagram illustrating a system 100 for processing payment transactions. According to various implementations of the invention, system 100 may be used to process payment transactions via payment devices. In some implementations, a payment device may include a chip-based payment device, such as an EMV capable payment device. The chip-based payment device may include a chip-based credit card, a chip-based debit card, and/or other chip-based payment device that may include a chip (with an embedded microprocessor and memory) that may be read via a reader device coupled to an acceptance device for the purposes of processing a payment transaction. In some implementations, the acceptance device may include a point of sale (POS) terminal, an ATM (automatic teller machine), a mobile device, and/or other EMV capable acceptance device. In various implementations of the invention, the reader device may interrogate/read the chip of the payment device.

In some implementations, the reader device may read a magnetic stripe of the payment device. In some implementations, the chip-based payment device may also include a magnetic stripe (which may be read in cases where merchant's business rules or payment processing network and issuer relationships may dictate that the payment transaction be processed via a magnetic stripe). In some implementations, the reader device may read cardholder information from a payment device, or otherwise read information, electrically, magnetically, or optically, from the payment device as would be appreciated.

In some implementations, cardholder information may be stored using various tangible media such as, for example, a magnetic stripe, a smart chip, a Radio Frequency Identification (“RFID”) tag, Near Field Communication (“NFC”) tag, or other tag that supports contactless communication protocols, and/or other tangible medium that can be used to store and retrieve the cardholder information. In some implementations, the medium may be coupled to various payment devices, which can include, for example, a payment card, a key fob, a mobile device (such as a mobile device having an NFC tag), or other devices that can house or otherwise be used to carry the medium.

In some implementations, the cardholder information may include a credit card number, debit card number, a bank account number, or other identifier that identifies a financial account/payment account used for the payment transaction. The payment account may be associated with the payment device (for example, payment card). In some implementations, the cardholder information may further include a name of the cardholder/account holder (such as a name of the user), a telephone number of the cardholder, a mailing address of the cardholder, and/or other information related to the payment transaction.

In some implementations, a payment transaction may include, for instance, an online purchase, a store purchase (including a purchase at a brick and mortar retail or other establishment associated with a merchant), a funds transfer (for example, Electronic Funds Transfer (“EFT”), which involves electronically transferring funds or money from one account to another), and/or other transaction that transfers money to/from a financial account.

In some implementations, the cardholder/account holder is a person/user or other entity that is a payment cardholder, a user using the system to make a payment, a user using the system to transfer funds, and/or other person or entity using the system to process a payment transaction. Those having skill in the art will appreciate that the invention described herein may work with various system configurations.

According to various implementations of the invention, system 100 may include, but is not limited to, a payment device 105, a reader device 110 (also referred to as a “reader”), an acceptance device 115, a merchant server 120, network 130, and a database 140. In some implementations, acceptance device 115, merchant server 120, and database 140 may be communicably coupled to one another via a network 130. Network 130 may include a Local Area Network, a Wide Area Network, a cellular communications network, a Public Switched Telephone Network, and/or other network or combination of networks.

In some implementations, payment device 105 may support a plurality of payment applications associated with an issuer (i.e., a financial institution, such as, a bank or other entity that issues the payment device). In some implementations, the issuer may load the payment applications onto the payment device when the payment device is issued. For example, payment device 105 may be a payment card issued by a first issuer, wherein a plurality of first payment applications associated with the first issuer may be loaded onto the payment device, or payment device 105 may be a payment card issued by a second issuer, wherein a plurality of second payment applications associated with the second issuer may be loaded onto the payment device, etc.

In some implementations, payment device 105 may include a chip-based payment device. The chip may include an embedded microprocessor and memory (not otherwise illustrated in FIG. 1). In some implementations, in addition to cardholder information, the chip memory may store issuer application selection criteria (IASC), and/or other information. In some implementations, the cardholder information, the issuer application selection criteria, and/or other information may be defined on the chip by the issuer during personalization and prior to issuing the payment device to the cardholder.

In some implementations, the issuer application selection criteria (IASC) may include issuer-defined criteria for application selection and may include, among other things, an application identifier (AID) associated with each payment application in the payment device, a cardholder verification method (CVM) associated with each payment application/AID in the payment device, and a primary account number (PAN) associated with the payment device.

In some implementations, the application identifier (AID) may include a registered application provider identifier (RID) which may be provided to the issuer by a registration authority, and a proprietary application identifier extension (PIX) which identifies different products associated with the issuer. For example, different products associated with an issuer, such as credit, debit, etc. may have a different PIX number. In other words, the PIX number enables the issuer to differentiate between different payment applications offered by the issuer and loaded onto the payment device.

In some implementations, a cardholder verification method may be used to evaluate whether the user presenting the payment device 105 at the acceptance device 115 is a legitimate cardholder. In some implementations, one or more CVMs may be associated with each payment application/AID in the payment device. A CVM may include online PIN, where the PIN is encrypted and verified online by the issuer; offline PIN, where the PIN is verified offline by the payment device; signature, where the cardholder signature is compared to signature on the back of the payment device (e.g., payment card); no CVM, where no CVM is used; and/or other verification methods. In some implementations, the PIN may include a conventional secret sequence of numbers associated with the financial account or other secret information used to authenticate the payment transaction.

In some implementations, the issuer may have an EMV-based card program. In some implementations, the issuer may request an operator of a payment brand to add the payment brand to its EMV-based card program (or issuer card program). In some implementations, the issuer may provide to the payment brand its issuer application selection criteria, and cryptographic keys associated with the issuer card program. In some implementations, in response to the request, the payment brand may be added to the issuer EMV-based card program, wherein the issuer application selection criteria and cryptographic keys are associated with the issuer's PANs (i.e., primary account numbers associated with payment devices issued by the issuer) for EMV processing.

In some implementations, the payment brand (operator of the payment brand) may identify the issuer card program as being processed by the payment brand. In some implementations, the issuer card program may be identified via an identifier that may include components of the IASC and a number of attributes contained within a payment network card program file. In some implementations, a payment network card program file may include card ranges, associated AIDs, associated CVMs, and/or other information. In some implementations, the payment network card program file may be distributed to merchant server 120 (also referred to as acquirer 120).

In some implementations, reader device 110 may be coupled to the acceptance device 115, wherein the reader device 110 may be configured to accept/read a payment device 105 (for example, a credit card, debit card, and/or other payment device/card) associated with a user (cardholder/account holder) performing a payment transaction. In some implementations, the acceptance device 115 may include a POS terminal associated with a merchant, an ATM, a mobile device, and/or other acceptance device. In some implementations, the reader device 110 may be removably and/or communicably coupled to the acceptance device 115 (via a wired link or a wireless link, for example). In some implementations, the reader device 110 may be embedded in the acceptance device 115. In some implementations, acceptance device 115 may be configured to determine geo-location information such that merchant/consumer (cardholder) interaction may take place based on the location of the consumer at the time a payment transaction is initiated.

In some implementations, the payment device 105 may include a chip-based payment device that includes a contact. In these implementations, when the payment device 105 is inserted into the acceptance device 115, the contact allows the chip to connect to the reader device 110 which reads data (for example, cardholder information, issuer application selection criteria, and/or other information) stored in the chip.

In some implementations, the payment device 105 may be a contactless chip-based payment device and the reader device 110 may be a contactless reader device. In these implementations, the chip may energized by the reader device 110 when the payment device 105 is held within a particular distance of reader device 110. The payment device 105 and reader device 110 exchange data (for example, cardholder information, issuer application selection criteria, and/or other information) via radio frequency or other near-field or contactless communication protocols.

In some implementations, acceptance device 115 may include a processor 116, a memory 118, and/or other components that facilitate the functions of acceptance device 115 described herein. In some implementations of the invention, processor 116 includes one or more processors configured to perform various functions of the acceptance device 115. In some implementations of the invention, memory 118 includes one or more tangible (i.e., non-transitory) computer readable media. Memory 118 may include one or more instructions that when executed configure processor 116 to perform the functions of acceptance device 115. In some implementations, memory 118 may include one or more instructions stored on tangible computer readable media that when executed at a remote device, such as reader device 110, cause the remote device to perform various functions of the remote device described herein and/or to facilitate interaction with merchant server 120, as described herein.

In some implementations, acceptance device 115 may store application selection preferences (ASP) associated with a plurality of payment applications supported by the acceptance device 115. In some implementations, a plurality of payment applications supported by the acceptance device 115 may be stored in memory 118, for example. In some implementations, the plurality of payment applications may be associated with different issuers.

In some implementations, application selection preferences may be associated with each payment application in the acceptance device 115. In some implementations, the application selection preferences associated with a payment application in the acceptance device 115 may include, among other things, merchant application selection criteria (MASC) associated with the payment application, requested payment amount associated with the payment transaction, and merchant category code (MCC), which is a number used to classify the business by the type of goods and services provided by the merchant.

In some implementations, the merchant application selection criteria may include merchant-defined criteria for application selection and may include, among other things, an application identifier (AID) associated with the payment application, a cardholder verification method (CVM) associated with the payment application/AID, a cost to use the payment brand, the reliability and speed associated with the payment brand, the approval rate associated with the payment brand, alliance agreements a merchant may have with a payment brand, statutory requirements, and a merchant-defined priority for the payment application.

In some implementations, the merchant server 120 may request that a payment application (AID) be added to acceptance device 115. In some implementations, the merchant server 120 may distribute the payment application to the acceptance device 115 or have it loaded directly to the acceptance device 115. In some implementations, the merchant server 120 may communicate application selection preferences to the acceptance device 115. Acceptance device 115 may store the received information, in memory 118, for example. In some implementations, the acceptance device 115 may accept the payment application/AID/application selection preferences without manual intervention.

According to various implementations of the invention, merchant server 120 may include a processor 122, a memory 125, and/or other components that facilitate the functions of merchant server 120 described herein. In some implementations of the invention, processor 122 includes one or more processors configured to perform various functions of the merchant server 120. In some implementations of the invention, memory 125 includes one or more tangible (i.e., non-transitory) computer readable media. Memory 125 may include one or more instructions that when executed configure processor 122 to perform the functions of merchant server 120. In some implementations, memory 125 may include one or more instructions stored on tangible computer readable media that when executed at a remote device, such as acceptance device 115, cause the remote device to perform various functions of the remote device described herein and to facilitate interaction with merchant server 120, as described herein.

In some implementations, database 140, which may include issuer application selection criteria provided by payment brands in which the merchant participates. The information may include identifiers for issuer card programs (such as ranges of card numbers) and their associated payment brands, AIDs, CVMs, MASC, and/or other information. In some implementations, database 140 may store the payment network card program file(s). According to various implementations of the invention, examples of database 140, include, for instance, a relational database, a filesystem, and/or other device or data representation configured for data storage.

FIG. 2 is a data flow diagram illustrating exemplary process relationships in a system for processing payment transactions, according to various implementations of the invention. In some implementations, a user (for example, cardholder) may insert, tap, swipe, or otherwise present a payment device 105 at a reader device 110 of acceptance device 115 to initiate a payment transaction.

In some implementations, payment device 105 may include a chip-based payment device and reader device 110 may read/obtain cardholder information, issuer application selection criteria (IASC) associated with a plurality of payment applications supported by the issuer and/or payment device, and/or other information from the payment device 105, in an operation 202. In some implementations, the reader device 110 may communicate the read data to the acceptance device 115. In some implementations, acceptance device 115 may receive cardholder information, IASC, and/or other information read from payment device 105, in an operation 204. In some implementations, the IASC may include issuer-defined criteria for application selection and may include, among other things, an application identifier (AID) associated with each payment application in the payment device, a cardholder verification method (CVM) associated with each payment application (AID) in the payment device, and a primary account number (PAN) associated with the payment device.

In some implementations, acceptance device 115, in an operation 206, may retrieve application selection preferences associated with a plurality of payment applications supported by the acceptance device, from memory 118, for example. In some implementations, acceptance device 115 may retrieve merchant application selection criteria (MASC) which may include merchant-defined criteria for application selection and may include, among other things, an application identifier (AID) associated with each payment application in the acceptance device, a cardholder verification method (CVM) associated with each payment application in the acceptance device, the cost to use the payment brand, the reliability and speed associated with the payment brand, the approval rate associated with the payment brand, alliance agreements a merchant may have with a payment brand, statutory requirements, and a merchant-defined priority for each payment application.

In some implementations, acceptance device 115 may communicate the received IASC and retrieved MASC to merchant server 120, in an operation 208. In some implementations, merchant server 120 may receive the IASC and the MASC and may determine a payment application (i.e., perform application selection) based on at least the received IASC and the MASC, in an operation 210.

In some implementations, merchant server 120 may perform a comparison between the IASC and the MASC. In some implementations, merchant server 120 may compare an application identifier (AID) associated with each payment application supported by the acceptance device 115 (i.e., in MASC) with application identifiers (AIDs) associated with the payment applications in the payment device 105 (i.e., in IASC).

In some implementations, each AID from the acceptance device 115 is compared with the AIDs in the payment device. In some implementations, merchant server 120 may generate a candidate list of AIDs in response to the comparison, in the operation 210. For example, as shown in FIG. 3, merchant server 120 may compare each AID in list A with each AID in List B. In response to a match, merchant server 120 may add the matching AID to the candidate list. In some implementations, merchant server 120 may initiate the comparison process with AID A in List A and may compare AID A against each AID in List B. Since, List B also includes AID A, the comparison results in a match and the matching AID (AID A) is added to the candidate list. In some implementations, the merchant server 120 may iterate through the remaining AIDs in List A and perform the comparison against each AID in List B. In some implementations, merchant server 120 may add each matching AID to the candidate list.

In some implementations, merchant server 120 may perform application selection based on the comparison. In some implementations, when only one matching AID exists (i.e., candidate list has only one matching AID), merchant server 120 may determine that only one mutually supported payment application exists. In other words, only one payment application exists that is supported by the payment device 105 and the acceptance device 115. In this case, merchant server 120 may select/determine the matching AID (i.e., associated payment application) from the candidate list, in operation 210.

In some implementations, when two or more matching AIDs exist (i.e., candidate list has two or more matching AIDs, as shown in FIG. 3), merchant server 120 may determine that more than one mutually supported payment application exists. In other words, more than one payment application exists that is supported by the payment device 105 and the acceptance device 115. In this case, merchant server 120 may select the matching AID (i.e., associated payment application) from the candidate list that has the highest merchant-defined priority (included in the MASC), in operation 210.

In some implementations, in response to a determination that more than one mutually supported payment application exists, merchant server 120 may determine whether the acceptance device 115 supports cardholder selection. In response to a determination that the acceptance device does not support cardholder selection, merchant server 120 may select the AID (i.e., payment application) that has the highest merchant-defined priority. In some implementations, in response to a determination that the acceptance device supports cardholder selection, the matching AIDs (i.e., payment applications) may be communicated to the acceptance device 115. The acceptance device 115 may (i.e., processor 116 may be configured to) generate an interface that displays the matching AIDs (i.e., payment applications) in a particular order. The particular order may be based on the merchant-defined priority associated with the payment applications (for example, ascending order). In some implementations, the interface may prompt the cardholder to select the AID (i.e., payment application).

In some implementations, when none of the AIDs from List A match AIDs from List B (i.e., candidate list is empty); the merchant server 120 may determine that no mutually supported payment applications exist. In other words, no payment applications exist that are supported by the payment device 105 and the acceptance device 115. In this case, merchant server 120 may communicate a message to the acceptance device 115 indicating that no matching AIDs exist. In some implementations, acceptance device 115 may terminate the payment transaction initiated by the payment device 105 in response to message.

In some implementations, merchant server 120, in the operation 210, may determine a payment application based on the IASC, MASC, a payment network card program file, and/or external information including, but not limited to, transaction processing costs, and/or other information. In some implementations, as shown in FIG. 3, merchant server 120 may utilize the IASC, MASC, and the payment network card program file (stored in database 140, for example) to determine the payment application (i.e., AID) and the associated CVM. In some implementations, merchant server 120 may perform a comparison between AIDs in the MASC, IASC, and the payment network card program file to determine matching AIDs and generate a candidate list of the matching AIDs.

Referring back to FIG. 2, merchant server 120 may communicate the determined/selected AID (i.e., identity of the selected payment application) to the acceptance device 115, in operation 212. In some implementations, merchant server 120 may communicate the selected AID and associated CVM (from the IASC) to the acceptance device 115.

In some implementations, acceptance device 115 may receive the selected AID and associated CVM from the merchant server 120. In some implementations, acceptance device 115 may prompt the cardholder (via the interface) for verification based on the received CVM, in operation 214. For example, when the received CVM indicates a signature, the acceptance device 115 may prompt the cardholder for the signature.

In some implementations, acceptance device 115 may communicate payment transaction data to merchant server 120, in operation 216. In some implementations, the payment transaction data may include, among other things, destination payment network, transaction amount, merchant information, the cardholder information received from the payment device, AID associated with the selected application, PAN associated with the payment device, and CVM data.

In some implementations, merchant server 120 may communicate the payment transaction data to a processing device (not otherwise illustrated in the figures) that routes the payment transaction data to an appropriate payment processing network (i.e., destination payment network).

In some implementations, while the operations 208, 210, and 212 have been described as being performed by a merchant server 120, these operations may be performed by the acceptance device 115, without departing from the scope of the invention. In some implementations, merchant server 120 may preload the acceptance device 115 with the MASC. In some implementations, the acceptance device 115 may compare AIDs in the MASC with AIDs in the IASC and may select an AID based on the comparison. In these implementations, the application selection may be performed based on data (e.g., MASC) locally cached at the acceptance device 115.

FIG. 4 is a flow diagram illustrating a process 400 for processing a payment transaction performed by the merchant server and/or the acceptance device, according to various implementations of the invention. The various processing operations and/or data flows depicted in FIG. 4 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations, process 400 may evaluate issuer application selection criteria, merchant application selection criteria, and/or payment network card program file, in an operation 402. In some implementations process 400 may perform a comparison between the issuer application selection criteria and the merchant application selection criteria. In some implementations, process 400 may compare an application identifier (AID) associated with each payment application supported by the acceptance device 115 (i.e., in MASC) with application identifiers (AIDs) associated with the payment applications in the payment device 105 (i.e., in IASC).

In some implementations, process 400 may generate a candidate list of AIDs in response to the comparison, in an operation 404. In some implementations, process 400 may compare each AID from the acceptance device with each AID from the payment device. In response to a match, process 400 may add the matching AID to the candidate list.

In some implementations, process 400 may perform application selection based on the comparison, in an operation 406. In some implementations, process 400 may select an AID (i.e., payment application) from the candidate list.

In some implementations, when only one matching AID exists (i.e., candidate list has only one matching AID), process 400 may determine that only one mutually supported payment application exists. In other words, only one payment application exists that is supported by the payment device 105 and the acceptance device 115. In this case, process 400 may select the matching AID (i.e., associated payment application) from the candidate list.

In some implementations, when two or more matching AIDs exist (i.e., candidate list has two or more matching AIDs), process 400 may determine that more than one mutually supported payment application exists. In other words, more than one payment application exists that is supported by the payment device 105 and the acceptance device 115. In this case, process 400 may select the matching AID (i.e., associated payment application) from the candidate list that has the highest merchant-defined priority (included in the MASC).

In some implementations, process 400 may, in an operation 402, evaluate the IASC, the MASC and the payment network card program file. In some implementations, process 400 may select a payment application based on the MASC, IASC, and/or payment network card program file. In some implementations, process 400 may perform a comparison between AIDs in the MASC, IASC, and the payment network card program file to determine matching AIDs and generate a candidate list of the matching AIDs.

The foregoing are non-limiting examples associated with various implementations of the invention. Other uses and implementations of system 100 with respect to various system components will be apparent to those skilled in the art based on the description below.

Implementations of the invention may be made in hardware, firmware, software, or any suitable combination thereof. Implementations of the invention may also be implemented as instructions stored on a machine-readable medium, which may be read and executed by one or more processors. A tangible and non-transitory machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method of processing a payment transaction, the method comprising:
evaluating issuer application selection criteria and merchant application selection criteria, wherein the issuer application selection criteria comprises first application identifiers associated with payment applications on a payment device and the merchant application selection criteria comprises second application identifiers associated with payment applications supported by an acceptance device;
generating a candidate list of payment applications, wherein the candidate list comprises one or more matching application identifiers determined based on the evaluation; and
determining a payment application to be used for processing the payment transaction from the candidate list.

2. The method of claim 1, evaluating the issuer application selection criteria and the merchant application selection criteria further comprising:
comparing each of the first application identifiers with each of the second application identifiers to determine the one or more matching application identifiers.

3. The method of claim 1, wherein the candidate list comprises at least two matching application identifiers, and wherein determining the payment application further comprising:
determining a payment application from the candidate list that has a highest merchant-defined priority.

4. The method of claim 1, wherein the candidate list comprises at least two matching application identifiers, and wherein determining the payment application further comprising:
receiving a manual selection of a payment application from the candidate list, wherein the at least two matching application identifiers are provided for selection in a particular order, wherein the particular order is based on the merchant-defined priority associated with the at least two matching application identifiers.

5. The method of claim 1, wherein said evaluating further comprising:
evaluating the issuer application selection criteria, the merchant application selection criteria, and a payment network card program file.

6. The method of claim 5, wherein the payment network card program file comprises third application identifiers associated with issuer card programs.

7. The method of claim 6, wherein said evaluating the issuer application selection criteria, the merchant application selection criteria, and the payment network card program file further comprising:
comparing each of the first application identifiers with each of the second application identifiers and each of the third application identifiers to determine the one or more matching application identifiers.

8. A system of processing a payment transaction, the system comprising:
one or more processors configured to:
evaluate issuer application selection criteria and merchant application selection criteria, wherein the issuer application selection criteria comprises first application identifiers associated with payment applications on a payment device and the merchant application selection criteria comprises second application identifiers associated with payment applications supported by an acceptance device;
generate a candidate list of payment applications, wherein the candidate list comprises one or more matching application identifiers determined based on the evaluation; and
determine a payment application to be used for processing the payment transaction from the candidate list.

9. The system of claim 8, wherein the processors configured to evaluate the issuer application selection criteria and the merchant application selection criteria are further configured to:
compare each of the first application identifiers with each of the second application identifiers to determine the one or more matching application identifiers.

10. The system of claim 8, wherein the candidate list comprises at least two matching application identifiers, and wherein the processors configured to determine the payment application are further configured to:
determine a payment application from the candidate list that has a highest merchant-defined priority.

11. The system of claim 8, wherein the candidate list comprises at least two matching application identifiers, and wherein the processors configured to determine the payment application are further configured to:
receive a manual selection of a payment application from the candidate list, wherein the at least two matching application identifiers are provided for selection in a particular order, wherein the particular order is based on the merchant-defined priority associated with the at least two matching application identifiers.

12. The system of claim 8, wherein the processors configured to evaluate the issuer application selection criteria and the merchant application selection criteria are further configured to:
evaluate the issuer application selection criteria, the merchant application selection criteria, and a payment network card program file.

13. The system of claim 12, wherein the payment network card program file comprises third application identifiers associated with issuer card programs.

14. The system of claim 13, wherein the processors configured to evaluate the issuer application selection criteria, the merchant application selection criteria, and the payment network card program file are further configured to:
compare each of the first application identifiers with each of the second application identifiers and each of the third application identifiers to determine the one or more matching application identifiers.
